(19) United States
(12) Patent Application Publication
(10) Pub. No.: US 2004/0096747 A1
(43) Pub. Date: May 20, 2004

(54) Electrolyte solution for electrochemical cells

(76) Inventor: Andree Schwake, Heidenheim (DE)

Correspondence Address: FISH & RICHARDSON PC, 225 FRANKLIN ST, BOSTON, MA, 02110, US

(21) Appl. No.: 10/470,824

(22) PCT Filed: Jan. 23, 2002
(86) PCT No.: PCT/DE02/00221

(30) Foreign Application Priority Data
Jan. 30, 2001 (DE) 101 03 994.8

(51) Int. Cl. H01M 10/40; H01G 9/035; H01G 9/155

(52) U.S. Cl. 429/326; 429/329; 429/330; 429/332; 429/331; 361/502; 361/504; 252/62.2

(57) ABSTRACT

Electrolyte solutions were suggested for electrochemical cells, for example for double-layer capacitors, which showed conductivities of more than 20 mS/cm at 25° C., at least comprising of a primary salt, which is released in a solvent alloy of “A” at least a solvent of high polarity and “B” at least a non-toxic solvent of low viscosity. Because of the low or non-availability of parts of acetonitrile, the electrolyte solutions are not in danger of a release of hydrogen cyanide if fire breaks out.

Electrochemical cells, such as double-layer capacitors, are used in the range of capacitors, as they can implement concurrently high capacitances at very small ESR. For example, when used as temporary energy storage, double-layer capacitors have to release or accept high energy connected to them in relatively short periods of a few seconds with a flow that is not that high. So that this can take place with as little loss as possible, the electrical internal resistance of the capacitors has to be minimized.

The internal resistance of the double-layer capacitors, along with the material of the electrode layers, the separator and the cell structure, is dependent essentially on the conductivity of the operating electrolyte. Electrolytes with a conductivity of more than 20 mS/cm at room temperature are required for double-layer capacitors of larger power density with which capacitors can work with sufficiently low internal resistance.

Solutions of primary salts in organic solvents cover known electrolytes for double-layer capacitors with cell tensions of more than 2V. The primary salts are organic compounds or show organic cations or anions, for example, on the basis of onium acids salts with nitrogen, sulphur or phosphorous as the central atom. Even other heterocyclical compounds with quaternary nitrogen atoms are suitable as cations. Suitable anions are, for example, the complex halide of boron or phosphorous, tetrafluoroborate, or hexafluorophosphate. A high degree of disassociation of salts is indispensable for the conductivity of these electrolyte solutions, which is supported by a high polar solvent. Primary salt solutions in pure solvents, like acetonitriles with high polar and low viscose properties, are known electrolyte solutions for double-layer capacitors, which achieve a conductivity of more than 20 mS/cm at 25° C. In WO 99/60587, an electrolyte solution with a conductivity of 36 mS/cm is revealed, which contains an N,N-dialkyl-1,4-diazabicyclo[2.2.2]octane diamine salt as primary salt and acetonitrile as the sole solvent.

The disadvantage of this highly conductive electrolyte solution containing acetonitrile is the fact that it is easily flammable and develops toxic hydrogen cyanide (HCN) in case of fire. Capacitors with such electrolyte solutions present a considerable risk in case of fire and moreover cause problems during the clean up.

The function of the instant invention is to provide an electrolyte solution with high conductivity, which avoids the aforementioned disadvantages of known electrolyte solutions.

An electrolyte solution that attempts to solve this characteristic is described in claim 1. Advantageous designs of the invention can be seen from further claims.

An electrolyte solution in accordance with the invention features a solvent compound, which does not develop any HCN in case of fire and is comprised of components which are assigned to three categories A, B and C. The most important element of the solvent is the component A, which at least incorporates a solvent with higher polarity. Solvents with high polarity mean here solvents, which favorably show a dielectric constant (DK)>10. The dielectric constant of a solvent can be determined in a decametre by methods, known to an expert. They are, for example, shown in the Rompp-Chemistry Lexicon (9^{th} Edition) under the term “Dielectric constant” (Pages 955-956), reference to which is made here to the full text.

The inventors have now recognized the fact that the high polarity alone of the solvent A in an electrolyte solution is not enough to obtain a sufficiently high conductivity. In fact, a number of high polar solvents possess a high viscosity, which is often >1 cP, and this affects the ion movement of the primary salts to be dissolved in it and prevents achieving a sufficiently high conductivity of the electrolyte solution.

A further solvent of low viscosity is added under the invention as a further element B, until combined with a sufficient quantity of a primary salt, an electrolyte solution of sufficiently lower viscosity is derived. The solvent of low viscosity seen as component B shows an advantageous viscosity of <1 cP. The viscosity of a solvent can be determined for example by means of an Ubbelohde-viscosimeter.

It can be seen that maximum conductivity can be achieved at a degree of thinning that is dependent on a solvent of component A, or with a viscosity connected with it. This maximum conductivity is not achieved with a solvent compound, which corresponds to the maximum polarity expressed by the dielectric constant of the solvent compounds of components A and B, but with a solvent mixture which does not have maximal polarity but ideal viscosity or thinning. The invention represents the best possible compromise between the possible high polarities with the possible low viscosity.

It will have an electrolyte solution, which shows a determined conductivity at 25° C with more than 20 mS/cm, which does not release HCN if fire breaks out. Such conductivities were possible till now only with solvent compounds with an acetonitrile share of more than 20 weight percentage. The invention thus shows for the first time a way to get electrolyte solutions for double-layer capacitors, which are suitable as quick energy temporary store, and which, in case of fire, do not develop any HCN.

High polar solvents for component A could be selected from Pyrrolidine, lactone, carbonates, sulfone, oxazolidinone, imidayzolidinone, amide or nitrile. In an electrolyte solution under the invention, it is better to contain component A in a proportion of at least 30 weight percent. It is preferable if component A, as a high polar solvent, is at least a cyclical carbonate, which is easily available, cost-effective and has high polarity. It is preferable if such a cyclical carbonate is at least 40 weight percentage of the entire electrolyte solution.

Starting with a suitable component A, the choice of component B is far less critical, as it is dependent exclusively on the compatibility with the components A and C and the reduction in viscosity related with it. Prevalent low viscosity solvents can be used as component B, as, for example, open-chained carbonates, ketones, aldehydes, ester or substituted benzene; however, solvents with sufficiently low vapour tension are preferable.

A further design of the invention could contain acetonitrile, the content or portion of which in the entire electrolytes is set at a maximum 20 weight percentage. With such a low content of acetonitrile, the danger of hydrogen cyanide developing if fire breaks out would be minimal.

Primary salts and alloys of primary salts can be selected as component C from the group of quaternary ammonium borates, ammonium fluoroalkylphosphate, ammonium fluoroalkylarsenate ammonium trifluoromethylsulfonate, ammonium bis(fluoromethanesulfonyl)imide or ammonium tris(fluoromethanesulfonyl)methide. In addition to ammonium, other cations can be used as cations, which can be chosen from the group of the pyridinium, morpholinium, lithium, imidazolium, and pyrrolidinium. Apart from the above-mentioned anions, perchlorate, tetrachloroaluminate or oxalatoborate, or compounds of these anions, can also be used. For even higher conductivities under the invention, melted salt with organic cations, which are available at room temperature in a liquid state, can be used. Such melted salts could be chosen on the basis of imidazolium cations or pyrrolidinium cations. Because of the high costs of these salts melted at room temperature, they are limited to special applications only, where the cost factor does not play a part. Good results with sufficiently high conductivities can also be achieved with standard primary salts, for example with Tri or Tetra ethyl ammonium tetrafluoroborate.

The invention is described in detail below using design examples: the relevant Table 1 shows the compounds of 7 electrolyte solutions under the invention together with the conductivity determined at 25° C. In all design examples, the same primary salt tetraethylammonium tetrafluorobrate has been used in a concentration of maximum 1.2 mol/l. Higher concentrations do not as a rule increase the conductivity, but increase additional costs, which could be avoided. The primary salt can also be substituted with other primary salts without significant changes in conductivity.

TABLE 1

| | Components | | | | | | |
|---|---|---|---|---|---|---|---|
| | A | | A/B | | B | | C |
| | [weight %] | | [weight %] | | [weight %] | | [Mol/l] |
| Example No: | 1 | 2 | 3 | 4 | 5 | 6 | 7 |
| Propylene- | 40 | | 24 | 40 | 40 | | |
| carbonate | | | | | | | |
| Ethylene- | 40 | 37 | 25 | 20 | 40 | 40 | 40 |
| carbonate | | | | | | | |
| Acetonitrile | 20 | 26 | 26 | 20 | 20 | | |
| γ-Butyric- | | | | 20 | | | |
| lactone | | | | | | | |
| Diethyl- | | 37 | | | | | |
| carbonate | | | | | | | |
| Acetone | | | 25 | | | | 60 |
| Methyl formate | | | | | | 60 | |
| Tetra ethyl- | 0.9 | 1.0 | 0.9 | 0.9 | 1.2 | 0.9 | 0.9 |
| ammonium tet- | | | | | | | |
| ra-fluoroborate | | | | | | | |
| Conductivity at | 23.9 | 25.0 | 33.1 | 24.1 | 27.9 | 31.0 | 33.4 |
| 25° C. | | | | | | | |
| [mS/cm] | | | | | | | |

The solvent compounds are comprised of up to four different individual solvents in the example, whereby some solvents of the Group A as well as the Group B are to be imputed, and can be applied to both categories. The apparent high proportion of acetonitrile in examples 2 and 3 gets reduced in the total electrolyte solvent, inclusive of the primary salt, to approximately 20%, so that the danger of the development of HCN can be classified as minor. The quantities of solvent components A and B are in weight percentage, based on the composition of the solvent specified. The quantity data for primary salt are based on concentration, based on mol/l electrolyte solution. It shows that all examples have conductivity values from here to 33.4 mS/cm, which make them really suitable for double-layer capacitors to be used in the service range.

Electrochemical double-layer capacitors are to be impregnated with electrolyte solutions under the invention for determining the electrochemical data. Its electrical data can be determined and compared with that of known comparable electrolyte solutions. The corresponding data is reproduced in Table 2:

TABLE 2

| | | HCN | | | |
|---|---|---|---|---|---|
| | | develop- | Conductivity | | |
| Salt | Solvent | ment | (mS/cm) | R [Ω] | C [F] |
| (C₂H₅)₄NBF₄0.9 | Aceto-nitril | yes | 54.2 | 9.8 | 139 |
| mol/l | 100% | | | | |
| (C₂H₅)₄NBF₄0.9 | γ-Butyric- | no | 17.4 | 33.7 | 126 |
| mol/l | lactone | | | | |
| | 100% | | | | |
| Example 2 | | Strongly | 28.2 | 22.6 | 142 |
| | | reduced | | | |

It shows that with the electrolyte solutions under the invention, comparative conductivity can be achieved, as with the known solutions, which contain a high concentration of acetonitrile. Thus, comparatively lower resistances are achieved in capacitors filled with it. As against the known electrolyte solutions of high conductivity, the electrolyte solutions under the invention resulted in no or starkly reduced development of hydrogen cyanide.

To find a suitable electrolyte solution, the following procedure is recommended. Take a primary salt—for example a standard primary salt—and release it in a polar solvent of Group A, until a given concentration to primary salt is achieved, for example 0.5 mol/l. Thereafter, the polar solvent is thinned continuously with a further lower viscose solvent of Group B, whereby the primary salt concentration is kept constant. For all compounds the conductivity is determined. It shows that an optimal conductivity value can be reached at a certain thinning grade. Thereafter, the content of primary salt is optimized, whereby gradually its proportions are increased. This procedure shows that at a certain optimal concentration value of the component C, no further increase in conductivity can be achieved. For an electrolyte under the invention, it is preferable to select the lowest concentration in primary salt with optimal conductivity.

Principally it is naturally possible, for optimization of a primary salt solution to go out in a lower viscose solvent (component B and to add high polar solution component A) or to increase the portion of the high polar solvent. As in the electrolyte solution under the invention, the part of component A usually is in the majority; the first recommended way is generally the most advantageous, at least as the inspected primary salts are not soluble in pure solvents of category B.

The procedure can be modified to that extent that as component A can be a compound of various high polar solvents. To thin the component A, and compounds of various lower viscose solvents component B can be added.

In further examples, besides the above-named solvents propylene and ethylene carbonate, γ-butyrolactone and acetonitriles and, 3 Methyl-2-Oxazolidinone can be used for Component A. Besides the aforementioned solvents, Component B with lower viscosity can be diethyl carbonate, acetone, methyl formate, ethyl acetate and/or ethylmethylketone. Besides tetraethylammonium tetrafluoroborate (C₂H₅)₄NBF₄, the primary salt can also be lithium hexafluorophosphate LiPF₆.

TABLE 3

| | Component | | | | | | | | | | | |
|---|---|---|---|---|---|---|---|---|---|---|---|---|
| | A | | | A/B | | | B | | | | C | |
| | [weight %] | | | [weight %] | | | [Weight %] | | | | [mol/l] | |
| Bps No. | 8 | 9 | 10 | 11 | 12 | 13 | 14 | 15 | 16 | 17 | 18 | 19 |
| PC | | | 50 | | | | | | 25 | | | |
| EC | 50 | 50 | | 40 | 40 | 50 | | | 25 | 40 | 40 | 70 |
| OX | | | | | | | 50 | 50 | | | | |
| γ-B | | | | | | | | | | | | |
| AC | 50 | | | | 60 | | | 50 | | 30 | 40 | |
| MF | | 50 | 50 | 60 | | | 50 | | 50 | 30 | 20 | |
| EA | | | | | | | | | | | | 30 |
| EMK | | | | | | 50 | | | | | | |
| TBF | | | 0.9 | 0.9 | 0.9 | 0.6 | 0.9 | 0.9 | 0.9 | 0.9 | 0.9 | 1.0 |
| LP | 0.9 | 0.9 | | | | | | | | | | |
| LF | 26.5 | 27.2 | 26.0 | 31.0 | 33.4 | 24.3 | 24.8 | 28.6 | 31.6 | 29.7 | 33.0 | 20.1 |

The abbreviations used in Table 3 are: PC Propylene carbonate; EC Ethylene carbonate; OX 3-Methyl-2-Oxazolidinone; γ-B γ-Butyriclactone; AC Acetone; MF Methyl formate; EA Ethyl acetate; EMK ethylmethylketones; TBF Tetraethylammonium tetrafluoroborate; LP Lithium hexafluorophosphate; and LF the conductivity of the electrolyte solutions in mS/cm at 25° C.

The high conductivity of the electrolyte solutions in accordance with the invention is noticeable in a lower ESR-value of double-layer capacitors, which can be operated with this electrolyte solution. Table 4 compares the electrical data of traditional capacitors with propylene carbonate as sole solvent (Example 21) with capacitors, which can be operated with three of the four above named electrolyte solution, (Examples 11, 12 and 19 from Table 3).

TABLE 4

| | | | Capa- | ESR [100 |
|---|---|---|---|---|
| Example | Salt | Solvent | city/F | Hz/mΩ] |
| 21 | 1 M (C₂H₅)₄NBF₄ | 100% propylene | 112 | 39 |
| | | carbonate | | |
| 11 | 0.9 M (C₂H₅)₄NBF₄ | See Table 3 No. 11 | 101 | 18 |
| 12 | 0.9 M (C₂H₅)₄NBF₄ | See Table 3 No. 12 | 123 | 13 |
| 19 | 0.9 M (C₂H₅)₄NBF₄ | See Table 3 No. 19 | 121 | 23 |

Based on this table, it is clear that capacitors with electrolyte solutions under the invention at approximate similar capacity would show considerably lower ESR-values than known capacitors with high polar but also higher viscose solvents.

With the recommended procedure, further electrolyte solutions under the invention can be found, the composition of which can strongly deviate from the example.

In any case, it is surprising, that the said high conductivity of more than 20 mS/cm can be achieved with the solvent compounds under the invention, which are not applied to maximal polarity.

1. Electrolyte solution for electrochemical cells with a conductivity of more than 20 mS/cm at 25° C. showing following components
A at least a solvent of high polarity with a DK>10,
B at least a solvent of lower viscosity <1 cP
C at least a primary salt.

2. Electrolyte solution according to one of the above claims, in which
Component A covers at least a solvent of high polarity that is selected from nitrile, lactone, carbonate, sulfone, oxazolidinone, imidazolidinone, pyrrolidone or amides
in the Component B at least a solvent of lower viscosity, which is selected from open-chained carbonates, ketones, aldehydes, ester or substituted benzenes.

3. Electrolyte solution according to one of the above claims
where Component A is included in a part of at least 30 weight %.

4. Electrolyte solution according to one of the above claims,
in which Component A comprises of at least a cyclical carbonate, which in the entire electrolyte solution has a portion of at least 40 weight %.

5. Electrolyte solution according to one of the above claims,
in which primary salts are contained as Component C, which exist at room temperature as a fluid or melted.

6. Electrolyte solution according to one of the above claims,
in which the primary salt comprises in the Component C and is selected from a combination of the following anions and cations:
Anions: PF₆—, AsF₆—, SO₂CF₃—. N(SO₂CF₃)₂—, C(SO₂CF₃)₃—, BOR₄—, BF₄—, ClO₄—, AlCl₄— or fluor alkyl phosphate, where R is an alkyl residue,
Cations: (C₂H₅)₄N⁺, (C₂H₅)₃CH₃N⁺, Li⁺, imidazolium, pyrrolidinium, pyridineium, or morpholinium.

7. Electrolyte solutions according to one of the above-mentioned claims,
according to which the Component C is Triethyl methyl or Tetra ethyl ammonium tetra fluoro borate.

8. Electrolyte solution according to one of the above-mentioned claims,
according to which the Component A is selected from one group, which contains the following solvent:
Propylene carbonate, Ethylene carbonate, 3-Methyl-2-Oxazolidinone, γ-butyrolactone or acetonitrile,
according to which the Component B is selected from one group, which contains the following solvent:
acetone, methyl formate, ethyl acetate, y-butyrolactone, acetonitrile or ethyl methyl ketone.

9. Electrolyte solution according to one of the above claims,
in which propylene carbonate and ethylene carbonate is present in Component A with a share of about 40 weight % each,
in which acetonitrile is present in Component B with a share of approx. 20 weight %.

10. Electrolyte solution according to claims 1 to 8,
in which ethylene carbonate is represented in Component A with a share of approx. 37 weight %
in which Component B is represented by a compound of acetonitrile with a share of approx. 26 weight % and diethyl carbonate with a share of approx. 37 weight %.

11. Electrolyte solution according to claims 1 to 8,
in which Component A is represented by a compound of propylene carbonate with a share of about 24 weight % and ethylene carbonate with a share of about 25 weight % is represented,
in which Component B is represented by a compound of acetonitrile with a share of approx. 26 weight % and acetone with a share of approx. 25 weight %.

12. Electrolyte solution according to claims 1 to 8,
in which Component A is represented by a compound of propylene carbonate with about 40 weight % and ethylene carbonate with a share of about 20 weight %,
in which Component B is represented by acetonitrile and y-butyrolactone with a share of approx. 20 weight %.

13. Electrolyte solution according to claims 1 to 8,
in which ethylene carbonate is represented in Component A with a share of about 40 weight %,
in which methyl formate is represented in Component B with a share of about 60 weight %.

14. Electrolyte solution according to the claims of 1 to 8,
in which Component A is represented by Ethylene carbonate with a share of approx. 40 weight %,
in which Component B is represented by acetone with a share of approx. 60 weight %.

15. Electrochemical double-layer capacitor with electrodes and a porous separator between it with the characteristic, that it includes an electrolyte solution according to one of the preceding claims.
